(19) United States
(12) Patent Application Publication
(10) Pub. No.: US 2026/0177659 A1
(43) Pub. Date: Jun. 25, 2026

(54) A RADAR TRANSCEIVER HOLDING BRACKET AND RADAR TRANSCEIVER ASSEMBLY

(71) Applicant: Magna Electronics Sweden AB, Vårgårda (SE)

(72) Inventors: Jonathan MOSS, Unterschleissheim (DE); Karen KOCHARYAN, Lowell, MA (US); Lisa GEISLER, Niederwerrn (DE); Pascal LORE, Yokohama, Kanagawa (JP); Krishnakant NAINWAL, Unterschleissheim (DE); Marcel PLIETH, Niederwerrn (DE)

(21) Appl. No.: 19/128,817

(22) PCT Filed: Nov. 8, 2023
(86) PCT No.: PCT/EP2023/081197

§ 371 Date: May 9, 2025

(30) Foreign Application Priority Data
Nov. 11, 2022 (SE) 2251327-0

(51) Int. Cl. G01S 7/02; H01Q 1/32; H01Q 1/42; H01Q 1/52; H01Q 17/00

(52) U.S. Cl. CPC G01S 7/027; H01Q 1/3233; H01Q 1/42; H01Q 1/52; H01Q 17/00

(57) ABSTRACT

A holding bracket (170) adapted to retain a radar transceiver (130) that comprises an antenna arrangement (131) having an antenna aperture plane (132) that has a vertical extension (V) and a horizontal extension (H). The holding bracket (170) is divided into an upper part (170A) and a lower part (170B), where the lower part is adapted to be positioned closer the ground (G) than the upper part (170A). The lower part (170B) comprises a microwave energy absorbing part (180) that is adapted to prevent reflected microwave energy (R2) from radiating towards the ground (G), the microwave energy absorbing part (180) comprising a bottom end (181) that is positioned farthest from the upper part (170A), and a top end (182) that is positioned closest to the upper part (170A). The microwave energy absorbing part (180) is adapted to extend between the bottom end (181) and the top end (182) mainly parallel to the vertical extension (V) of the antenna aperture plane (132) when the radar transceiver (130) is mounted.

### CROSS REFERENCE TO RELATED APPLICATIONS

This U.S. utility patent application is a § 371 national phase of PCT international patent application No. PCT/EP2023/081197, filed 8 Nov. 2023, which claims the priority benefit of Sweden (SE) Application No. 2251327-9, filed 11 Nov. 2022, the contents of which are incorporated herein by reference in their entirety.

### FIELD OF THE INVENTION

The present disclosure relates to radar transceivers and in particular to installation of radar transceivers in vehicles.

### BACKGROUND

A radar transceiver is a device arranged for transmission and reception of radar signals in a radar frequency band. Radar transceivers are commonly used in vehicles for monitoring vehicle surroundings. Automatic Cruise Control (ACC) functions, Emergency Braking (EB) functions, Advanced Driver Assistance Systems (ADAS) and Autonomous Drive (AD) are some examples of applications where radar data represents an important source of information on which vehicle control may be based.

Vehicle radar transceivers are often arranged hidden behind vehicle body parts, such as a front or a rear vehicle bumper or fascia. This placement is often chosen due to aesthetic reasons, but there is also a need to protect the radar transceiver from mechanical impact, moisture and dirt.

A drawback associated with hiding radar transceivers behind vehicle body parts is that the radar transmission must penetrate the body part in order to monitor the vehicle surroundings. Some of the radar energy radiated as a main beam from an antenna surface can be reflected back from the body part into the cavity behind the body part, towards the antenna surface with an elevation angle equal to double that of the bumper's elevation angle.

This radar energy will then be re-reflected from the antenna surface and create unwanted side-lobe patterns that can be in a downwards direction.

The downwards energy illuminates the ground in front of the radar transceiver at a particular range. Due to roughness and other ground features, some energy will scatter back towards the radar transceiver and return to the receiver antennas of the radar transceiver via the same double bounce mechanisms as on the transmissions.

Hence the radar transceiver will detect the ground clutter as an apparent real target and it will appear at a zero or near-zero elevation to the radar, even though it is from the ground. The radar transceiver will attempt to determine the azimuth angle of the target by examining the phase across the array of receiver antennas. However because the bumper will often have an azimuth angle offset θ, the azimuth angle will be correspondingly wrong on the order of 2×θ.

Ground clutter is generally not of interest and can normally be removed by means of algorithms built into the radar transceiver, where these algorithms are adapted to compare the measured apparent radial speed of a target to the measured azimuth angle of the target. However, because the azimuth angle is not correct, the algorithm will not consider the target to be ground stationary.

It is therefore an object to avoid the ground clutter being detected by the radar.

### SUMMARY AND INTRODUCTORY DESCRIPTION OF EMBODIMENTS OF THE INVENTION

This object is achieved by a holding bracket adapted to retain a radar transceiver that comprises an antenna arrangement having an antenna aperture plane that has a vertical extension and a horizontal extension. The holding bracket is divided into an upper part and a lower part, where the lower part is adapted to be positioned closer the ground than the upper part. The lower part comprises a microwave energy absorbing part that is adapted to prevent reflected microwave energy from radiating towards the ground, where the microwave energy absorbing part comprises a bottom end that is positioned farthest from the upper part, and a top end that is positioned closest to the upper part. The microwave energy absorbing part is adapted to extend between the bottom end and the top end mainly parallel to the vertical extension of the antenna aperture plane when the radar transceiver is mounted.

This means that unwanted side-lobes are prevented from radiating past the absorbing part. Any energy reflected in the absorbing part is trapped and will not be able to propagate further.

Furthermore, since the absorbing part is comprised in the holding bracket, and not any other part in a vehicle such as a bumper, the position of the absorbing part relative the antenna arrangement is always fixed. This is advantageous since if there are movements such as vibrations, this does not affect the relationship between the absorbing part and the antenna arrangement.

According to some aspects, the holding bracket is adapted to hold a radar transceiver such that the antenna arrangement is positioned in the upper part when the radar transceiver is mounted.

This means that the antenna arrangement and the absorbing part are positioned in different parts of the holding bracket, the absorbing part not interfering with the main beam.

According to some aspects, the top end of the microwave energy absorbing part is adapted to extend adjacent to the upper part.

In particular when the antenna arrangement is adapted to be positioned in the upper part when the radar transceiver is mounted, this means that the energy absorbing part can be adjacent to the antenna arrangement, providing a high degree of reduction of propagation of unwanted microwave energy while avoiding interference with the main lobe.

According to some aspects, the microwave energy absorbing part and the holding bracket are integrally formed.

This means that the energy absorbing part is formed in the same material as the rest of the holding bracket, resulting in an inexpensive manufacturing process.

According to some aspects, the microwave energy absorbing part is attached to rest of the holding bracket by any of; an adhesive layer, a snap-fit mechanism, an interference fit mechanism, the use of additional screws or clips, and/or by ultrasonic welding.

This means that the absorbing part can be formed in another material than the rest of the holding bracket, such that the energy absorbing part can be formed in a specially suited absorbing material. Furthermore, the absorbing part can be designed so that it can be retro-fitted to an existing holding bracket such that a modified holding bracket according to the present disclosure, including the absorbing part, is formed.

According to some aspects, the microwave energy absorbing part is adapted to be positioned at a certain minimum distance from the radar transceiver when mounted.

This enables microwave energy that has been reflected in the absorbing part 180 to be effectively trapped.

There are also disclosed herein radar transceiver assemblies, and vehicles associated with the above-mentioned advantages.

### BRIEF DESCRIPTION OF THE DRAWINGS

The present disclosure will now be described more in detail with reference to the appended drawings, where:

FIG. 1 shows a schematic top view of a vehicle;

FIG. 2 illustrates a schematic front view of a radar transceiver attached to a holding bracket according to a first example; and

FIG. 3 is a side section view of FIG. 2 with radar reflections indicated.

### DETAILED DESCRIPTION

The inventive concept will now be described more fully hereinafter with reference to the accompanying drawings, in which certain embodiments of the inventive concept are shown.

This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

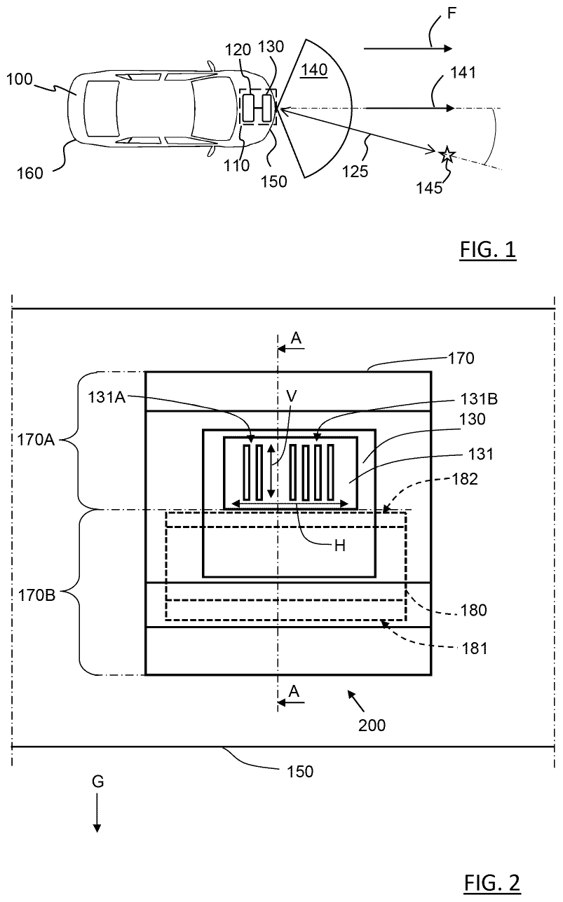

FIG. 1 shows a vehicle 100 equipped with a vehicle radar system 110. The system 110 comprises a control unit 120 and at least one radar transceiver 130. The control unit 120 and the radar transceiver 130 may be comprised in a single physical unit or they may be distributed over more than one physical unit.

According to an example, the vehicle radar transceiver 130 is arranged for generating and transmitting radar signals in the form of frequency modulated continuous wave (FMCW) signals, sometimes also referred to as radar chirp signals, and to receive reflected radar signals 125, where the transmitted signals have been reflected by an object 145.

The present disclosure is not limited to FMCW radar waveforms. Rather, the disclosed concepts and techniques can be applied to many different radar waveforms. In particular, the techniques disclosed herein are applicable to Orthogonal Frequency Division Multiplex (OFDM) radar, and to Pulse Modulated Continuous Wave (PMCW) radar. One example of OFDM radar is the stepped OFDM radar waveform described in EP 3323151 A1.

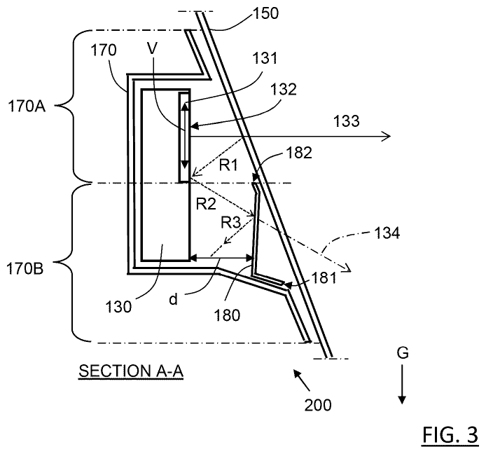

The radar transceiver 130 is associated with a field of view 140. In case the radar transceiver is a front radar, a boresight direction 141 of the radar often coincides with a center line of the field of view, where the boresight direction 141 here also coincides with a forward direction F of the vehicle 100. In case the vehicle radar is instead configured as a side radar or a rearward facing radar, then the boresight direction may point in some other angle compared to the forward direction F of the vehicle 100. As shown in FIG. 2 and FIG. 3, that is a section of FIG. 2, the radar transceiver 130 comprises an antenna arrangement 131 having an antenna aperture plane 132 that has a vertical extension V and a horizontal extension H. The vertical extension V is adapted to run parallel to, or in, an elevation plane and the horizontal extension H is adapted to run parallel to, or in, an azimuth plane.

The antenna arrangement 131 comprises a first antenna element arrangement 131A, for example a transmitter antenna element arrangement 131A, and a second antenna element arrangement 131B, for example a receiver antenna element arrangement 131B. According to some aspects, each antenna element arrangement 131A, 131B comprises one or more antenna arrays, each antenna array comprising a plurality of antenna elements such as for example patch antennas or slot antennas. In the example of FIG. 2, the first antenna element arrangement 131A comprises two antenna arrays and the second antenna element arrangement 131B comprises four antenna arrays. This is only an example, the antenna arrangement 131 can be configured in any suitable manner with any type and number of antenna elements, where the antenna elements can be arrange in arrays or be alone.

The antenna arrangement 131 is shown to be positioned at an upper part of the radar transceiver 130, but can of course be mounted at suitable position of the radar transceiver 130.

The radar transceiver 130 is mounted behind a body part of the vehicle 100. This vehicle body part may be, e.g., a front bumper 150 or a rear bumper 160.

As mentioned initially, reflections in a body part such as a bumper 150, 160 may give rise to unwanted radar side-lobes. Even though a vehicle radar typically has a narrow elevation beam-width, the effect of reflections in vehicle body parts may result in side-lobes at a non-zero elevation (or azimuth), such as pointing more towards the ground. These side-lobes may contribute to an increased level of clutter, which is undesired.

This is illustrated in FIG. 3, where a main beam 133 that is reflected in the bumper 150 is gives rise to a first reflection R1. The first reflection is reflected in the radar transceiver 130, possibly in the antenna aperture plane 132, which gives rise to a second reflection R2 that at least partly may constitute a side-lobe 134 that detects ground clutter that is believed to be a real target since the side-lobe 134 emanates from the main lobe 133.

This detected ground clutter arises when the bumper 150 is further away from the antenna arrangement 131 at the bottom of the antenna arrangement 131 than at the top of the antenna arrangement 131. This is because the mirroring effect of the bumper 150 and the antenna arrangement 131 creates the unwanted side-lobe 134, which is pointing outwards and downwards.

There is a holding bracket 170, adapted to retain the radar transceiver 130, the holding bracket 170 being divided into an upper part 170A and a lower part 170B, where the lower part is adapted to be positioned closer the ground G than the upper part 170A. The lower part 170B comprises a microwave energy absorbing part 180 that is adapted to prevent reflected microwave energy R2 from radiating towards the ground G. The microwave energy absorbing part 180 comprises a bottom end 181 that is positioned farthest from the upper part 170A, and a top end 182 that is positioned closest to the upper part 170A.

This means that the bottom end 181 is the part of the absorbing part 180 that is adapted to be positioned farthest from the upper part 170A, and that the top end 182 is the part of the absorbing part 180 that is adapted to be positioned closest to the upper part 170A.

According to some aspects, the ground G is the ground that a vehicle 100 is position on when the holding bracket 170 is mounted in that vehicle 100 as indicated with an arrow in FIG. 2 and FIG. 3.

According to the present disclosure, the microwave energy absorbing part 180 is adapted to extend between the bottom end 181 and the top end 182 mainly parallel to the vertical extension V of the antenna aperture plane 132 when the radar transceiver 130 is mounted.

In this context, according to some aspects, the term “mainly parallel” means that the microwave energy absorbing part 180 is adapted to extend between the bottom end 181 and the top end 182 in a manner that is more parallel to the vertical extension V of the antenna aperture plane 132 than perpendicular to the vertical extension V of the antenna aperture plane 132 when the radar transceiver 130 is mounted.

This means that unwanted microwave energy, such as the second reflection R2, mainly, or almost completely, is prevented from reaching the bumper 150, and the unwanted side-lobe 134 is prevented. The absorbing part 180 is manly adapted to absorb microwave energy, but a relatively small third reflection R3 might occur, but that reflected energy is trapped and will not give rise to any unwanted side-lobes.

Furthermore, since the absorbing part 180 is comprised in the holding bracket 170, and not the bumper 150, the position of the absorbing part 180 relative the antenna arrangement 131 is always fixed. This is advantageous since if the bumper 150 moves in a different way than the holding bracket 170, for example due to vibrations, this does not affect the relationship between the absorbing part 180 and the antenna arrangement 131.

This relationship is important since the closer the absorbing part 180 comes to the antenna aperture plane 132, and even the more the absorbing part 180 covers the antenna aperture plane 132, the more the second reflection R2 and the unwanted side-lobe 134 will be reduced, but at the same time the main beam 133 will have reduced strength. It is desired to reduce the second reflection R2 and the unwanted side-lobe 134 as much as possible while at the same time affecting the main beam 133 as little as possible.

Even during mounting the present disclosure is advantageous since, if the absorbing part 180 should be attached to another part, for example the bumper 150, it would be difficult to align the absorbing part 180 accurately relative to the antenna arrangement 131.

If the absorbing part 180 should be attached to the bumper 150, the bumper 150 may tend to sag downwards over the life of the vehicle, which again would result in misalignment of the absorbing part 180 relative to the antenna arrangement 131. Also, accidents may result in that the bumper 150 may be displaced such that the absorbing part 180 becomes misaligned relative to the antenna arrangement 131.

According to some aspects, the holding bracket 170 is adapted to hold a radar transceiver 130 such that the antenna arrangement 131 is positioned in the upper part 170A when the radar transceiver 130 is mounted.

This means that the antenna arrangement 131 and the absorbing part 180 are positioned in different parts of the holding bracket 170, the absorbing part 180 not interfering with the main beam 133.

According to some aspects, the top end 182 of the microwave energy absorbing part 180 is adapted to extend adjacent to the upper part 170A.

In particular when the antenna arrangement 131 is adapted to be positioned in the upper part 170A when the radar transceiver 130 is mounted, this means that the energy absorbing part 180 can be adjacent to the antenna arrangement 131, providing a high degree of reduction of propagation of unwanted microwave energy such as the second reflection R2 and the unwanted side-lobe 134 while avoiding interference with the main lobe 133.

Practically, it may be decided how high the top of the absorbing part 180 should be relative to the antenna arrangement 132 based on the distance between the bumper 150 and the antenna aperture plane 132, and the degree to which the second reflection and the corresponding side-lobe 134 needs to be attenuated. The closer the absorbing part 180 comes to the antenna aperture plane 132, and even the more the absorbing part 180 covers the antenna aperture plane 132, the more the second reflection R2 and the unwanted side-lobe 134 will be reduced, but at the same time the main beam 133 will have reduced strength.

The greater the distance between the bumper 150 and the antenna aperture plane 132, the farther from the antenna aperture plane 132 the absorbing part 180 can be positioned.

According to some aspects, the microwave energy absorbing part 180 is adapted to be positioned at a certain minimum distance d from the radar transceiver 130 when mounted. This enables microwave energy that has been reflected in the absorbing part 180, such as the third reflection R3, to be effectively trapped.

According to some aspects, the microwave energy absorbing part 180 and the rest of the holding bracket 170 are integrally formed.

This means that the energy absorbing part 180 is formed in the same material as the rest of the holding bracket 170, resulting in an inexpensive manufacturing process.

According to some aspects, the microwave energy absorbing part 180 is attached to rest of the holding bracket 170 by any of; an adhesive layer, a snap-fit mechanism, an interference fit mechanism, the use of additional screws or clips, and/or by ultrasonic welding.

This means that the absorbing part 180 can be formed in another material than the rest of the holding bracket 170, such that the energy absorbing part 180 can be formed in a specially suited absorbing material. Furthermore, the absorbing part 180 can be designed so that it can be retro-fitted to an existing holding bracket such that a modified holding bracket according to the present disclosure, including the absorbing part, is formed.

According to some aspects, the absorbing part 180 has a relative permittivity Er in the range 8.0-10.0. This results in that impinging microwave energy is reflected away from the absorbing part 180.

According to some aspects, the absorbing part 180 has a loss tangent tan o that exceeds 0.1 and more preferably exceeds 0.3.

According to some aspects, the absorbing part 180 is formed in a mouldable plastic material with embedded carbon particles.

The present disclosure is not limited to the examples described above, but may vary freely within the scope of the appended claims. For example, the microwave energy absorbing part 180 can have many shapes but should extend mainly parallel to the antenna aperture plane 132 when the radar transceiver 130 is mounted. In this way, microwave energy that is reflected away from the absorbing part 180 is trapped and will not give rise to any unwanted side-lobes or other unwanted residues.

The radar transceiver 130 can be mounted in any suitable manner in the holding bracket 170, for example upside-down.

As apparent in the most general case, the upper part 170A and the lower part 170B can have any suitable respective extension, the one shown in FIG. 2 and FIG. 3 is only an example. Since the lower part 170B comprises the microwave energy absorbing part 180, if the absorbing part 180 extends partly over the antenna aperture plane 132, the lower part 170B will also, at least partly, extend over the antenna aperture plane 132. The lower part 170B may have an extension that exceeds the extension of the absorbing part 180.

When the antenna arrangement 131 is adapted to be positioned in the upper part 170A when the radar transceiver 130 is mounted, the lower part 170B, and thus the absorbing part 180 will not extend over the antenna aperture plane 132.

The terms microwave energy absorbing part 180 and absorbing part 180 are used interchangeably.

While the above description constitutes a preferred embodiment of the present invention, it will be appreciated that the invention is susceptible to modification, variation and change without departing from the proper scope and fair meaning of the accompanying claims.

1. A holding bracket adapted to retain a radar transceiver that comprises an antenna arrangement having an antenna aperture plane that has a vertical extension and a horizontal extension, the holding bracket being divided into an upper part and a lower part, where the lower part is adapted to be positioned closer the ground than the upper part, where the lower part comprises a microwave energy absorbing part that is adapted to prevent reflected microwave energy from radiating towards the ground, the microwave energy absorbing part comprising a bottom end that is positioned farthest from the upper part, and a top end that is positioned closest to the upper part, wherein the microwave energy absorbing part is adapted to extend between the bottom end and the top end substantially parallel to the vertical extension of the antenna aperture plane when the radar transceiver is mounted.

2. The holding bracket according to claim 1, wherein the holding bracket is adapted to hold a radar transceiver such that the antenna arrangement is positioned in the upper part when the radar transceiver is mounted.

3. The holding bracket according to claim 1, wherein the top end of the microwave energy absorbing part is adapted to extend adjacent to the upper part.

4. The holding bracket according to claim 1, wherein the microwave energy absorbing part and the holding bracket are integrally formed.

5. The holding bracket according to claim 1, wherein the microwave energy absorbing part is attached to rest of the holding bracket by any of; an adhesive layer, a snap-fit mechanism, an interference fit mechanism, the use of additional screws or clips, and/or by ultrasonic welding.

6. The holding bracket according to claim 1, wherein the microwave energy absorbing part is adapted to be positioned at a certain minimum distance from the radar transceiver when mounted.

7. A radar transceiver assembly comprising a radar transceiver and a holding bracket according to claim 1.

8. A vehicle comprising the radar transceiver assembly according to claim 7.
